(19) United States
(12) Patent Application Publication
(10) Pub. No.: US 2025/0116562 A1
(43) Pub. Date: Apr. 10, 2025

(54) ENHANCED LEAK DETECTING GASKETS AND RELATED METHODS

(71) Applicant: LGC US ASSET HOLDINGS, LLC, HOUSTON, TX (US)

(72) Inventors: DALE NORMAN, HOUSTON, TX (US); MICHAEL JUSTINN GENERAL, HOUSTON, TX (US)

(21) Appl. No.: 18/480,791

(22) Filed: Oct. 4, 2023

(51) Int. Cl. G01M 3/04; G01M 3/16

(52) U.S. Cl. CPC G01M 3/04; G01M 3/16

(57) ABSTRACT

Disclosed are gaskets and related methods for detecting fluid leaks at flange connections. A leak detecting gasket may comprise at least one sealing portion of a gasket core having a first thickness. The at least one sealing portion has first and second opposing sealing surfaces configured to contact corresponding first and second sealing ends of fluid conduits. The gasket may comprise at least one non-sealing portion disposed along an outer perimeter of the core, where the non-sealing portion has a thickness less than the first thickness, and has first and second opposing surfaces configured not to contact the first and second sealing ends. The gasket includes a leak detection system comprising a carrier structure extending from the non-sealing portion, and having a detection component that provides an indication in response to contact from fluid passing from the central opening and across at least one of the first or second sealing surfaces.

### TECHNICAL FIELD

The disclosed principles relate generally to flange connections, and more particularly to leak detecting gaskets and related methods for detecting gas (such as flammable, explosive, or deadly gases including, but not limited to, hydrogen) leaks at flange connections using a gasket.

### BACKGROUND

Hydrogen is the smallest element in the universe; thus, it is difficult to contain. Elemental hydrogen most commonly exists as a diatomic gas, H₂. As a result, providing an effective seal against the leakage of hydrogen where two components are joined together, such as at a flange connection of two pipe or tubes, has proven quite difficult. Additionally, hydrogen gas is extremely flammable. Consequently, detecting any leakage of hydrogen at such connection junctions is a crucial safety priority.

Unfortunately, cost effective solutions to effectively detect H₂ at a flange connection have not been conventionally available. Previous attempts at detecting H₂ at a flange connection are either ineffective at detecting leakage of the gas or are overly expensive for the application. One approach to detect leaking hydrogen gas is to cover the flange with a special housing having a hydrogen detector. The housing must cover the flange to direct leaking hydrogen gas to the detector located at the top of the housing. However, such hydrogen detectors cost at least $1000 each and require power to function, further complicating their use. Because a plant may have many flanged connections among the piping running throughout the complex this approach quickly becomes cost-prohibitive.

Accordingly, what is needed in the art is an effective and inexpensive solution for detecting the leakage of hydrogen gas at such flanged connections or unions in order to reduce the risks associated with hydrogen leakage, such as the associated fires, explosions, and combustion. The disclosed principles provide such a solution.

### SUMMARY

The disclosed principles are directed to gaskets and related methods for detecting hydrogen gas leaks at flange connections. In one aspect, the disclosed principles provide for a leak detecting gasket configured to seal sealing ends of first and second components having a fluid, such as hydrogen, passing therethrough. In one embodiment, such a leak detecting gasket comprises a gasket core surrounding a central opening configured to receive the fluid therethrough, and at least one sealing portion of the gasket core having a first thickness. In such embodiments, the at least one sealing portion has first and second opposing sealing surfaces configured to contact corresponding first and second sealing ends of the first and second components. In addition, the gasket may comprise at least one non-sealing portion disposed along all of an outer perimeter of the gasket core, where the at least one non-sealing portion has a second thickness less than the first thickness and has first and second opposing surfaces configured not to contact the first and second sealing ends of the first and second components. Furthermore, a gasket in accordance with this embodiment includes a leak detection system comprising at least one detection component and optionally a carrier structure outwardly extending from the at least one non-sealing portion. In some embodiments, the at least one detection component may be incorporated into a gasket's body itself. In other embodiments, the at least one detection component may be disposed on the carrier structure. The at least one detection component provides a notice in response to contact from fluid passing from the central opening and across at least one of the first or second sealing surfaces.

In another aspect, the disclosed principles provide for a leak detecting gasket comprising a gasket core surrounding a central opening configured to receive the fluid therethrough, and at least two sealing portions of the gasket core having a first thickness. Each of the at least two sealing portions having first and second opposing sealing surfaces configured to contact corresponding first and second sealing ends of the first and second components. Such an embodiment of a gasket also comprises a first non-sealing portion disposed along all of an outer perimeter of the gasket core, where the first non-sealing portion has a second thickness less than the first thickness, and has first and second opposing surfaces configured not to contact the first and second sealing ends of the first and second components. Additionally, the gasket includes a second non-sealing portion disposed between two of the at least two sealing portions, where the second non-sealing portion has a third thickness less than the first thickness, and has first and second opposing surfaces configured not to contact the first and second sealing ends of the first and second components in order to create cavities on opposing sides of the gasket. These cavities are configured to funnel fluid leaking from the central opening and across one of the sealing portions. Moreover, these embodiments of a leak detecting gasket further comprise a leak detection system comprising at least one passageway in contact with one or more of the cavities and configured to receive the funneled leaking fluid therefrom. The detection system also includes at least one detection component, where the at least one detection component provides a notice in response to contact from fluid received from the at least one passageway. The at least one detection component may be disposed on the exterior of the gasket core. In further embodiments, the leak detection system may include a carrier structure outwardly extending from the at least one non-sealing portion with the at least one passageway communicating leaked fluid to at least one detection component disposed on the carrier structure.

Other aspects, embodiments and features of the invention will become apparent from the following detailed description of the invention when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE FIGURES

The novel features believed characteristic of this disclosure are set forth in the appended claims. This disclosure itself, however, as well as a preferred mode of use, further objectives, and advantages thereof, will be best understood by reference to the following detailed description of illustrative embodiments when read in conjunction with the accompanying drawing, in which:

FIG. 1A illustrates a plan view of a first embodiment of a leak detecting gasket, in accordance with the disclosed principles;

FIG. 1B illustrates a cross sectional view taken along line A-A of the embodiment of a leak detecting gasket illustrated in FIG. 1A;

FIG. 2A illustrates a plan view of a second embodiment of a leak detecting gasket, in accordance with the disclosed principles;

FIG. 2B illustrates a cross sectional view taken along line B-B of the embodiment of a leak detecting gasket illustrated in FIG. 2A;

FIG. 3A illustrates a plan view of a third embodiment of a leak detecting gasket, in accordance with the disclosed principles;

FIG. 3B illustrates a cross sectional view taken along line C-C of the embodiment of a leak detecting gasket illustrated in FIG. 3A;

FIG. 4A illustrates a plan view of a fourth embodiment of a leak detecting gasket, in accordance with the disclosed principles;

FIG. 4B illustrates a cross sectional view taken along line D-D of the embodiment of a leak detecting gasket illustrated in FIG. 4A;

FIG. 4C illustrates a cross sectional view taken along line E-E of the embodiment of a leak detecting gasket illustrated in FIG. 4A;

FIG. 5A illustrates a plan view of a fifth embodiment of a leak detecting gasket, in accordance with the disclosed principles;

FIG. 5B illustrates a cross sectional view taken along line F-F of the embodiment of a leak detecting gasket illustrated in FIG. 5A;

FIG. 5C illustrates a cross sectional view taken along line G-G of the embodiment of a leak detecting gasket illustrated in FIG. 5A;

FIG. 5D illustrates a plan view of an embodiment of a carrier structure in accordance with the present disclosure.

FIG. 6A illustrates a plan view of a sixth embodiment of a leak detecting gasket, in accordance with the disclosed principles;

FIG. 6B illustrates a cross sectional view taken along line H-H of the embodiment of a leak detecting gasket illustrated in FIG. 6A;

FIG. 6C illustrates a cross sectional view taken along line I-I of the embodiment of a leak detecting gasket illustrated in FIG. 6A;

FIG. 7A illustrates a plan view of a seventh embodiment of a leak detecting gasket, in accordance with the disclosed principles;

FIG. 7B illustrates a cross sectional view taken along line J-J of the embodiment of a leak detecting gasket illustrated in FIG. 7A; and

FIG. 7C illustrates a cross sectional view taken along line K-K of the embodiment of a leak detecting gasket illustrated in FIG. 7A.

FIG. 8A illustrates a plan view of an embodiment of a leak detecting gasket in accordance with the present disclosure.

FIG. 8B illustrates a cross sectional view taken along line A-A of the embodiment of a leak detecting gasket illustrated in FIG. 8A.

FIG. 9A illustrates a plan view of an embodiment of a leak detecting gasket, in accordance with the present disclosure.

FIG. 9B illustrates a cross sectional view taken along line A-A of the embodiment of a leak detecting gasket illustrated in FIG. 9A.

FIG. 9C illustrates a cross sectional view taken along line B-B of the embodiment of a leak detecting gasket illustrated in FIG. 9A.

FIG. 10A illustrates a plan view of an embodiment of a leak detecting gasket in accordance with the present disclosure.

FIG. 10B illustrates a plan view taken of an embodiment of a carrier structure in accordance with the present disclosure.

FIG. 10C illustrates a cross sectional view taken along line A-A of the embodiment of a leak detecting gasket illustrated in FIG. 10A.

FIG. 10D illustrates a cross sectional view taken along line B-B of the embodiment of a carrier structure illustrated in FIG. 10B.

FIG. 10E illustrates a cross sectional view taken along line C-C of the embodiment of a carrier structure illustrated in FIG. 10B.

FIG. 11A illustrates a plan view of an embodiment of a carrier structure in accordance with embodiments of the present disclosure.

FIG. 11B illustrates a side view of an embodiment of a carrier structure in accordance with embodiments of the present disclosure.

FIG. 11C illustrates a cross sectional view taken along line A-A of the embodiment of a carrier structure illustrated in FIG. 11B.

FIG. 12 illustrates a plan view of an embodiment of a leak detecting gasket in accordance with the present disclosure.

FIG. 13 illustrates a perspective view of an embodiment of a leak detecting gasket in accordance with the present disclosure.

FIG. 14 illustrates a side view of an embodiment of a leak detecting gasket in accordance with the present disclosure.

FIG. 15 illustrates a plan view of an embodiment of a leak detecting gasket in accordance with the present disclosure.

FIG. 16 illustrates a perspective view of an embodiment of a leak detecting gasket in accordance with the present disclosure.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. Although multiple embodiments are shown and discussed in great detail, it will be apparent to those skilled in the relevant art that some features that are not relevant to the present invention may not be shown for the sake of clarity.

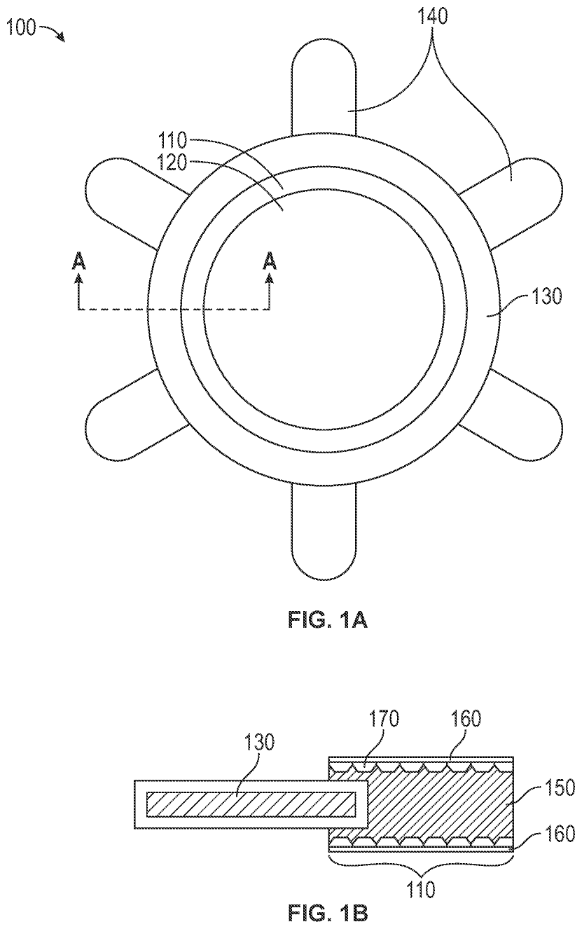

Looking initially at FIG. 1, illustrated is a plan view of a first embodiment of a leak detecting gasket 100, in accordance with the disclosed principles. FIG. 1A illustrates a cross sectional view taken along line A-A of the embodiment of the leak detecting gasket 100 illustrated in FIG. 1. This embodiment of the leak detecting gasket 100 is discussed with reference to both FIG. 1 and FIG. 1A collectively.

The gasket 100 includes a sealing portion 110 surrounding a central opening 120. The opening 120 is sized to permit the passage of fluid therethrough from one component to another, such as two adjoining fluid conduits, when the gasket 100 is positioned between the two components to provide a sealed connection. In this embodiment, the sealing portion 110 and the central opening 120 are circular, but other shapes for these components, and for the gasket 100 as whole, may also be constructed in accordance with the disclosed principles.

Positioned all around the outer perimeter of the sealing portion 110 of the gasket 100 is a non-sealing portion 130. Extending from multiple positions of the non-sealing portion 130 is a leak detection system. This embodiment of the leak detection system is comprised of a plurality of carrier structures 140 outwardly extending from an outer perimeter of the non-sealing portion 130. Additionally, the leak detection system includes a leak detection component, discussed in detail below, disposed on each of the carrier structures 140.

FIG. 1A illustrates that the sealing portion 110 is comprised of a gasket core 150 defining the central opening 120, as well as a sealing material 160 formed on opposing surfaces of the gasket core 150 that is provided as a rigid material such as metal. In some embodiments, the gasket core 150 and the non-sealing portion 130 are integrally formed from a single material. In other embodiments, such as the embodiment illustrated in FIG. 1A, the core 150 and the non-sealing portion 130 are coupled together when forming the gasket 100. For example, the two may be welded together in embodiments where the core 150 and the non-sealing portion 130 are compatible metals. In other embodiments where the core 150 and the non-sealing portion 130 are both non-metal materials, the two may be joined together via adhesion, heat welding, chemical bonding, an interference fit, or any other material joining technique.

In exemplary embodiments, the sealing material 160 is a compressible material and provides the opposing sealing surfaces of the gasket 100. In more specific embodiments, the compressible material 160 may be provided as a graphite, PTFE, or thermoplastic facing suitable for the gasket's particular requirements and defining the first and second opposing sealing surfaces of the sealing portion 110. Of course, as with all embodiments in accordance with the disclosed principles, other materials advantageously providing the sealing surfaces may also be employed. As also illustrated in FIG. 1A, in this embodiment of the gasket 100, the metal gasket core 150 comprises first and second pluralities of ridges 170 extending towards each of the corresponding first and second sealing ends of the first and second components between which the gasket 100 is placed to provide a seal. In exemplary embodiments, the ridges 170 are provided a pointed peaks or serrations formed on the rigid core 150 and carry the first and second opposing sealing surfaces of the gasket 100. Such ridges 170 may be provided so as to provide alternating peaks or areas of increased contact between the compressible material 160 and the sealing surfaces of the adjoining conduits as the gasket 100 is compressed between the adjoining conduits. In other embodiments, the ridges 170 may provide different surface geometries such as sinusoidal or trapezoidal geometries.

As shown in FIG. 1A, the sealing portion 110 has a thickness that is greater than the thickness of the non-sealing portion 130. By providing the sealing portion 110 of the gasket 100 with a greater thickness, the first and second opposing sealing surfaces 160 of the sealing portion 110 are configured to contact corresponding first and second sealing ends of the first and second components (e.g., adjoining conduit flanges, not illustrated), while the non-sealing portion 130 does not contact the first and second components. As such, each of the carrier structures 140 extending from the non-sealing portion 130 carry a detection component that provides a notice in response to contact from fluid passing from the central opening and across or through at least one of the first and second sealing surfaces 160. Any such passing fluid would be a leak in the seal between the first and second components and the gasket 100 positioned therebetween.

In one embodiment, the detection component is disposed on opposing outer surfaces of the carrier structures 140 positioned to be contacted by fluid leaking from the central opening 120 across the first or second sealing surface 160. In some embodiments, the detection component is provided as a material that visibly changes in response to being contacted by certain fluids. For example, the detection component may be a sensing paint, tape or similar material, such as a hydrogen sensing paint or tape, that changes colors when contacted by hydrogen. Such a paint or similar detection material provides a visible indicator that a leak is occurring at the gasket 100 where the first and the second components are joined. Additionally, or alternatively, the non-sealing portion 130 may include the detection material to assist in such leak notification. In a specific exemplary embodiment, the carrier structures 140 are provided as one or more rigid substrates 140 extending from the non-sealing portion 130 of the gasket. Such rigid substrates 140 may be sized to extend away from the gasket 100 sufficiently to provide a easily identifiable visible indicator of a leak at the gasket 100 to a worker visually inspecting various fluid conduit connections employing a gasket 100 as disclosed herein.

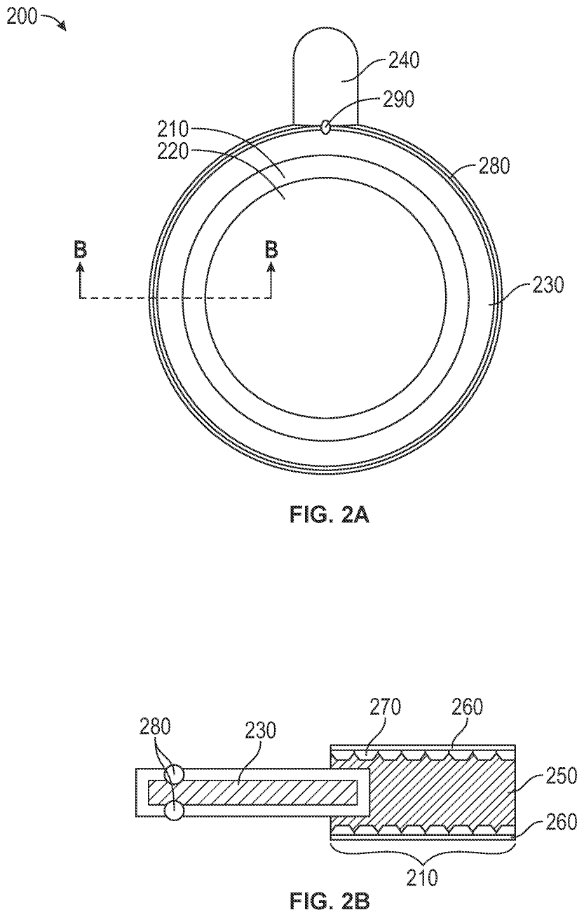

Turning now to FIG. 2, illustrated is a plan view of a second embodiment of a leak detecting gasket 200, in accordance with the disclosed principles. FIG. 2A illustrates a cross sectional view taken along line B-B of the embodiment of a leak detecting gasket 200 illustrated in FIG. 2. This embodiment of the leak detecting gasket 200 is discussed with reference to both FIG. 2 and FIG. 2A collectively.

This embodiment of a gasket 200 constructed in accordance with the disclosed principles again includes a sealing portion 210 surrounding a central opening 220. As before, the opening 220 is sized to permit the passage of fluid therethrough from one fluid conduit to another when the gasket 200 is used to provide a seal between sealing flanges on the two adjoining conduits. In this embodiment, the sealing portion 210 and the central opening 220 are again circular, but other shapes for these components, and for the gasket 200, may also be constructed in accordance with the disclosed principles.

A non-sealing portion 230 of the gasket 200 again surrounds all of the outer perimeter of the sealing portion 210. In this embodiment, another version of a leak detecting system is extending from a portion of the perimeter of the non-sealing portion 230. This embodiment of the leak detection system is comprised of a single carrier structure 240 outwardly extending from the non-sealing portion 230. Additionally, the leak detection system includes a leak detection component disposed on the extending carrier structure 240, and which is discussed in further detail below. Also, a plurality of such extending carrier structures 240 may also be employed. In other embodiments, the leak detection component may be disposed on the non-sealing portion 230.

FIG. 2A illustrates that the sealing portion 210 is again comprised of a gasket core 250, an inner diameter of which defines the central opening 220. The gasket core 250 in this embodiment is also provided as a rigid material such as a metal, and a sealing material 260 is again formed on opposing surfaces of the core 250. In some embodiments, the gasket core 250 and the non-sealing portion 230 are integrally formed from a single material, while in other embodiments, the core 250 and the non-sealing portion 230 are coupled together when forming the gasket 200. For example, the two components may be welded together in embodiments where the core 250 and the non-sealing portion 230 are compatible metals. In other embodiments where the core 250 and the non-sealing portion 230 are both non-metal materials, the two may be joined together via adhesion, heat welding, chemical bonding, an interference fit, or any other material joining technique.

In this illustrated embodiment, the sealing material 260 is also a compressible material providing the opposing sealing surfaces of the gasket 200. In some embodiments, the compressible material 260 may again be provided as a graphite facing defining the first and second opposing sealing surfaces of the sealing portion 210. Of course, as with all embodiments in accordance with the disclosed principles, other materials advantageously providing the sealing surfaces 260 may also be employed. As with the prior embodiment discussed above, in this embodiment of the gasket 200, the metal gasket core 250 comprises first and second pluralities of ridges 270 extending towards each of the corresponding sealing ends of the first and second adjoining conduits that the gasket 200 seals. The ridges 270 are again provided as pointed peaks or serrations formed on the rigid core 250 and carry the first and second opposing sealing surfaces 260 of the gasket 200.

As shown in FIG. 2A, the sealing portion 210 has a thickness that is greater than the thickness of the non-sealing portion 230. By providing the sealing portion 210 with a greater thickness than the non-sealing portion 230, the first and second opposing sealing surfaces 260 of the sealing portion 210 are configured to contact corresponding first and second sealing ends (e.g., flanges) of the first and second conduits, while the non-sealing portion 230 does not contact the first and second conduits. However, this embodiment of the leak detecting gasket 200 includes a seal 280 positioned proximate an outer perimeter edge of the non-sealing portion 230. As shown, such a seal 280 is provide on both upper and lower surfaces of the non-sealing portion 230. Moreover, these opposing seals 280 may be positioned and sized to contact the first and second sealing surfaces of first and second fluid conduits when the gasket 200 is used to provide the seal between such adjoining conduits. The opposing seals 280 may be additionally, or alternatively, positioned and sized to contact recessed, or otherwise non-sealing, surfaces of the fluid conduits. In exemplary embodiments, the seals 280 are provided as o-rings, and in such embodiments, grooves or channels may be formed into the corresponding surfaces of the non-sealing portion 230 to receive and hold the o-rings 280 in position. Additionally, although only one seal 280 is shown on each opposing surface of the non-sealing portion 230, two or more such seals 280 may also be employed.

The combination of the seals 280 and the sealing surfaces 260 of the sealing-portion 210 contacting the contact surfaces of the first and second conduits, along with the surfaces of the non-sealing portions 230 not contacting the first and second conduits, form cavities on opposing sides of the gasket 200 and the contact surfaces of the flanges of the adjoining conduits. As a result, should a leak develop between the sealing surfaces 260 of the sealing-portion 210 and the first and second conduits, the leaking fluid will pass into one or both of these cavities depending on which side of the gasket 200 the leak has formed. Thus, this embodiment of a leak detecting gasket 200 further includes the carrier structure 240 extending from a portion of the non-sealing portion 230, and carrying a detection component that provides a notice in response to contact from fluid leaking into the cavity(ies). As before, the detection component may be provided as a material that visibly changes in response to being contacted by certain fluids, such as a hydrogen detecting paint or tape.

More specifically, the carrier structure 240, which in this embodiment is provided as a rigid substrate outwardly extending from the non-sealing portion 230, may carry the detection component, be it active or passive (such as a fluid detecting paint, tape, sensor, or similar detecting material or structure), on both its opposing surfaces so that it may be visible from either side of the conduit junction having the gasket 200. Any fluid leaking into one of the cavities would be funneled through the cavities to the detection component, and the leaking fluid's contact on the detection component would provide a visual indicator that leaking fluid is present. In embodiments where the detection component is a hydrogen detecting paint carried on a substrate, the detection component could be positioned at the top of the gasket 200 such that leaking hydrogen would float upward through the cavity(ies) to the detection component, and thereby contact the hydrogen detecting paint disposed on the substrate. Moreover, the detection component may again be sized to extend away from the gasket 200 sufficiently to provide such a visible indicator of a leak at the gasket 200 to a worker visually inspecting the conduit connection. Additionally, a check valve 290 may be provided where the detection component, such as a rigid substrate, is joined to the non-sealing portion 230. Other components that function similarly to a check valve (i.e., permitting only one-way flow) may also be employed such that leaking fluid can escape the cavity(ies) but nothing can pass from the outside into the cavities. For example, a deteriorating or breakaway seal may be provided that gives way to the leaking fluid such that it reaches the detection component.

In some embodiments, multiple detection components may also be provided on or extending from a gasket. The detection component(s) may also be provided as any of a number of various means (including active or passive) of detecting the presence of a leaking fluid, and thereafter providing an indication that the leak is occurring such as a detecting paint, tape, sensor, or other comparable material or structure. For example, in some embodiments the detection component may be provided as an electronic system. Such an electronic detection system may include a means for providing an electronic notification of the detected leaking fluid. Such an electronic detection system may include a wired or wireless transmitter for transmitting a signal regarding the detected leaking fluid by the detection component. In such embodiments, a plurality of electronic detection systems may be used in corresponding leak detecting gaskets as disclosed herein so that all conduit junctions employing these gaskets may be monitored by a single system. Furthermore, such electronic detection system(s) may instead, or additionally, include visual and audible notifications when leaking fluid is detected. For example, one or more lights may be illuminated when a leak is detected, or a sound played, either on the electronic detection system itself or a device to which the electronic detection system is connected when a leaking fluid is detected.

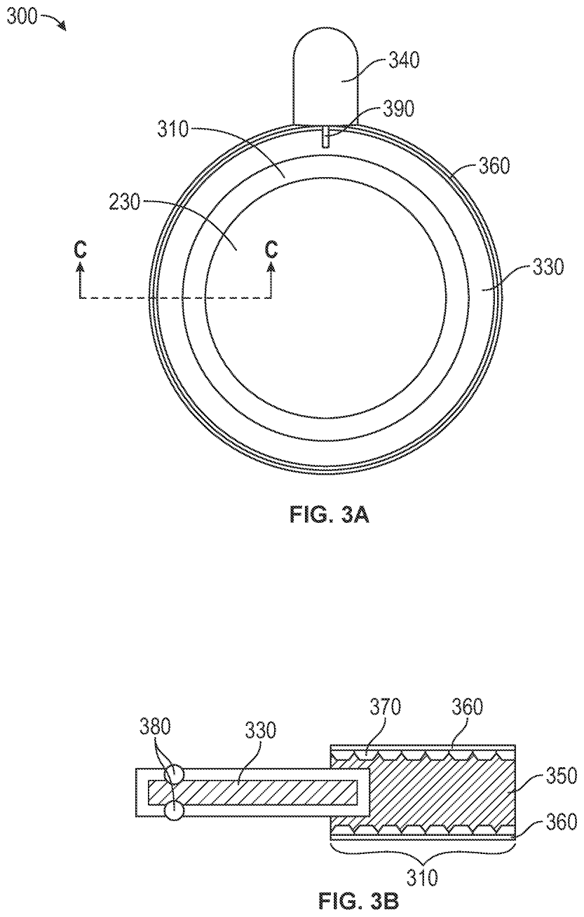

Turning now to FIG. 3, illustrated is a plan view of a third embodiment of a leak detecting gasket 300, in accordance with the disclosed principles. FIG. 3A illustrates a cross sectional view taken along line C-C of the embodiment of a leak detecting gasket 300 illustrated in FIG. 3. This embodiment of the leak detecting gasket 300 is discussed with reference to both FIG. 3 and FIG. 3A collectively.

This embodiment of a leak detecting gasket 300 constructed in accordance with the disclosed principles is substantially similar to the embodiment illustrated in FIGS. 2 and 2A. As such, this embodiment of the gasket 300 again includes a sealing portion 310 surrounding a central opening 320, which are again circular but other shapes for these components and for the gasket 300 may also be constructed in accordance with the disclosed principles. A non-sealing portion 330 of the gasket 300 again surrounds all of the outer perimeter of the sealing portion 310. FIG. 3A illustrates that the sealing portion 310 is again comprised of a rigid gasket core 350, and a sealing material 360 is again formed on opposing surfaces of the core 350. The gasket core 350 and the non-sealing portion 330 may again be integrally formed, while in other embodiments the core 350 and the non-sealing portion 330 are coupled together using any advantageous material bonding technique.

The sealing material 360 is again a compressible material, such as a graphite facing or other advantageous sealing material as described previously. As with other embodiments disclosed herein, the gasket core 350 comprises first and second pluralities of ridges 370 extending outwardly and carrying the first and second opposing sealing surfaces 360 of the gasket 300. This embodiment of the leak detecting gasket 300 again includes a seal 380 positioned proximate an outer perimeter edge of opposing surfaces of the non-sealing portion 330. Each of these seals 380 may again be provided as o-rings, and grooves or channels may be formed into the corresponding surfaces of the non-sealing portion 330 to receive and hold the o-rings 380 in position. Additionally, as before, multiple seals 380 on each opposing surface of the non-sealing portion 330 may also be employed. The combination of the seals 380 and the sealing surfaces 360 of the sealing-portion 310 contacting the contact surfaces of first and second conduits, along with the surfaces of the non-sealing portions 330 not contacting the first and second conduits, form cavities on opposing sides of the gasket 300. Thus, as described above, should a leak develop between the sealing surfaces 360 and the first and second conduits, the leaking fluid will pass into one or both of these cavities.

Coupled to a portion of the outer edge of the non-sealing portion 330 is a leak detecting system again comprising a single carrier structure 340 outwardly extending from the gasket 300. This carrier structure 340 again carries a detection component to that provides a notice in response to contact from fluid leaking into the cavity(ies). This can again be via a material that visibly changes in response to being contacted by certain fluids, such as a hydrogen detecting paint. Any fluid leaking past the sealing surfaces 360 into one of the cavities would be funneled through the cavities to the detection component, and the leaking fluid's contact on the detection component would provide a visual indicator that leaking fluid is present. The carrier structure 340 may again be sized to extend away from the gasket 300 sufficiently to provide such a visible indicator of a leak at the gasket 300 to someone visually inspecting the conduit connection. Additionally, rather than the check valve 290 provided in the gasket 200 embodiment illustrated in FIG. 2, the gasket 300 embodiment illustrated in FIG. 3 may include an open pathway 390. The open pathway 390 functions by allowing leaking fluid from one of the cavities to flow through the open pathway 390 such that it reaches the detection component.

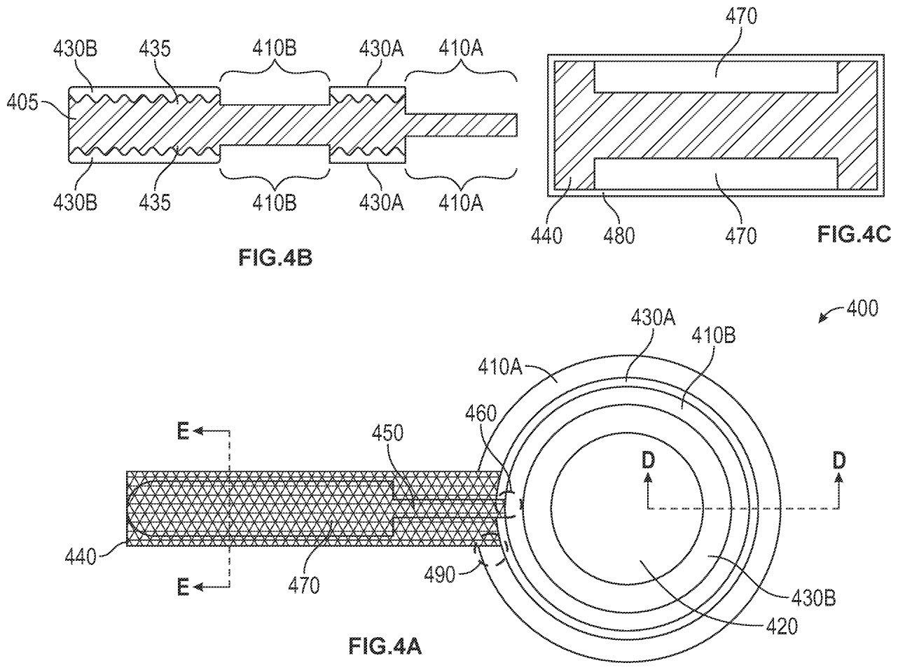

Looking now at FIG. 4, illustrated is a plan view of a fourth embodiment of a leak detecting gasket 400, in accordance with the disclosed principles. FIG. 4A illustrates a cross sectional view taken along line D-D of the embodiment of a leak detecting gasket 400 illustrated in FIG. 4. This embodiment of the leak detecting gasket 400 is initially discussed with reference to FIGS. 4 and 4A collectively.

As with other embodiments of a leak detecting gasket in accordance with the disclosed principles, this embodiment of the gasket 400 comprises a circular shape; however, other shapes are also possible. As such, this version of the gasket 400 is used to seal the ends of first and second conduits, such as piping or other conduits used to transport a fluid. In this illustrated embodiment, the gasket 400 may be used to seal tubing or piping used to transport hydrogen gas, but other uses are also encompassed within the principles disclosed herein.

The illustrated gasket 400 is again constructed with a core 405, which may be constructed from a rigid material such as metal, or may be constructed from a semi-rigid or non-rigid material, such as a plastic material, or even a cardboard or paper-based material. Of course, as with all embodiments in accordance with the disclosed principles, the core 405 of the leak detecting gasket 400 may be made from any advantageous material. Also as before, the core 405 provides the primary structure of the gasket 400 and surrounds a central opening 420 through the gasket for the passage of a fluid. Also included in this embodiment is a first non-sealing portion 410A having opposing non-sealing surfaces formed integrally with the core 405, and extending outwardly and around a perimeter of the gasket 400. Alternatively, the first non-sealing portion 410A may be coupled to the outer perimeter of the core 405, as discussed above with other embodiments, using any advantageous material bonding techniques. Additionally, in other embodiments, the opposing surfaces of the first non-sealing portion 410A may include seals, such as o-rings (not illustrated), positioned proximate the outer edge of the non-sealing portion 410A on both opposing surfaces.

This embodiment of the gasket 400 differs from prior embodiments in that it includes a second non-sealing portion 410B also having opposing surfaces, as seen in FIG. 4A. The thickness of the core 405 at the second non-sealing portions 410B may be the same or different than the thickness of the first non-sealing portions 410A discussed above. In the illustrated embodiment, the thickness of the second non-sealing portion 410B is greater than the thickness of the first non-sealing portion 410A.

This embodiment of a leak detecting gasket 400 also includes first and second sealing portions 430A, 430B formed on opposing surfaces of the gasket core 405 facing the sealing surfaces of conduits sealed together by the gasket 400. These sealing portions 430A, 430B include sealing surfaces comprised of advantageous sealing materials. Such materials may be compressible materials, and, as discussed above, may include a graphite facing or other advantageous material. Additionally, in this particular embodiment, each sealing surface of the sealing portions 430A, 430B is carried on a plurality of outwardly extending features 435. As with ridges 170 described previously, these features 435 may again comprise various geometries (such as a sinusoidal or trapezoidal geometry, serrations, other smooth, peaked, or otherwise protruding features, or some combination thereof) to assist in sealing between the sealing portions 430A, 430B and the contact portions of the adjoining conduits.

As can be seen in FIG. 4A, providing the second non-sealing portions 410B between the first and second sealing portions 430A, 430B creates a cavity on each opposing side of the gasket 400 when the gasket 400 is placed between the sealing surfaces of the adjoining conduits. As discussed in detail above, these cavities will funnel fluid leaking from the central opening 420 and across the second sealing portions 430B. A leak detection system 440 is again provided extending from the first non-sealing portion 410A, which may again be provided as a rigid substrate 440. The carrier structure 440 is coupled to the gasket 400, in this embodiment on an area of the first non-sealing portion 410A. Additionally, a passageway 450 may be provided on each of the opposing sides of the carrier structure 440, and these passageways 450 can be connected to the cavities formed by the second non-sealing portions 410B via a first fluid junction 460. As such, if leaking fluid is present in the cavity on either side of the gasket 400 at the seal formed by second non-sealing portions 410B, that leaking fluid will pass from the cavity(ies), through the first fluid junction 460, and into one of the passageways 450.

The carrier structure 440 may also be formed with detection pockets 470 on each of the opposing sides of the carrier structure 440 and each in fluid connection with a corresponding opening such as passageway 450. FIG. 4B illustrates a cross-sectional view of a portion of the carrier structure 440 taken along line E-E. This cross-sectional view illustrates the detection pockets 470 on opposing sides of the carrier structure 440. Additionally, the carrier structure 440 in this embodiment of a leak detecting gasket 400 includes a detection component 480 disposed on the exterior surfaces of the carrier structure 440, and providing one of the enclosing surfaces of each of the detection pockets 470. The detection component 480 is selected such that as fluid leaking from the second sealing portion 430B of the gasket 400 fills the detection pockets 470, the detection component 480 provides an indicator that leaking fluid has been detected. In some embodiments, the detection component 480 may be a hydrogen detecting thin film when the fluid passing through the gasket 400 is hydrogen. In such embodiments, the carrier structure 440 may be positioned at the top of the gasket 400 when sealed between two adjoining conduits, and thus any leaking hydrogen would float upwards into one or both of the passageways 450 and then into one or both of the detection pockets 470. The hydrogen detecting film 480 would then provide a visual indication of the leaking hydrogen gas, such as by turning a different color, etc. Additionally, or alternatively, a detection component may be configured to provide other indications (auditory or via a display) through measurement of a change in electrical resistivity of the detection component. The carrier structure 440 may again be sized to extend away from the gasket 400 sufficiently to provide such a visible indicator of a leak at the gasket 400 to someone visually inspecting the conduit connection.

In addition to the first fluid junction 460, the leak detection system in this embodiment of a gasket 400 may further include a second fluid junction disposed on the opposite face of the gasket to facilitate communication of fluid to both detection pockets 470 in carrier structure 440. Specifically, as discussed above, the carrier structure 440 is connected to a point along the perimeter of the first non-sealing portion 410A and in contact with a side of the first sealing portion 430A. As such, if a leak occurs between one of the sealing surfaces of the first sealing portion 430A and a contact surface of one of the adjoining fluid conduits, the leaking fluid can contact the detecting film 480 on the outer portion of the carrier structure 440 proximate the first sealing portion 430A. Once contacted, the detecting film 480 can then provide a visual indication of the leak in the manner discussed above.

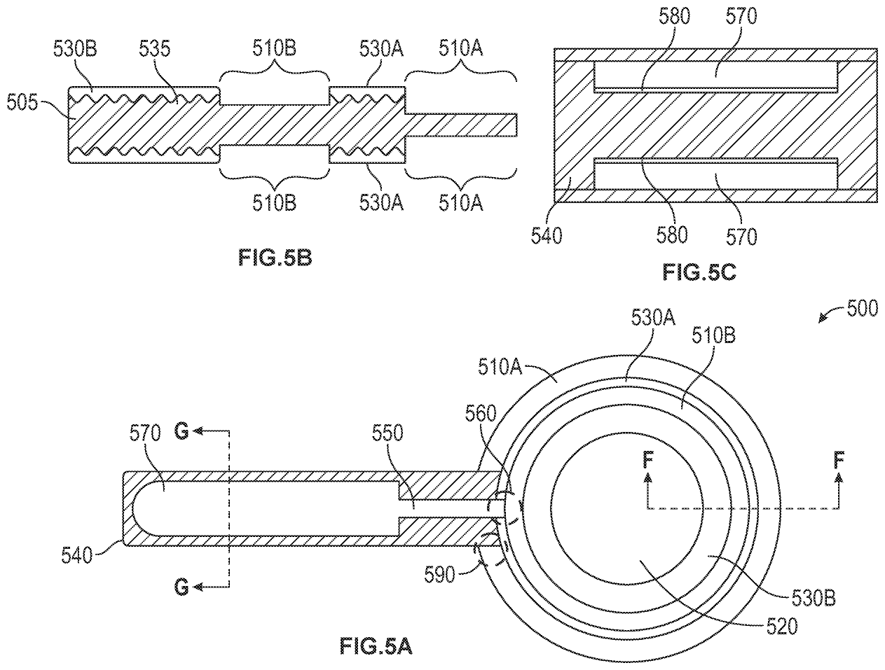

Referring now at FIG. 5, illustrated is a plan view of a fifth embodiment of a leak detecting gasket 500, in accordance with the disclosed principles. FIG. 5A illustrates a cross sectional view taken along line F-F of the embodiment of a leak detecting gasket 500 illustrated in FIG. 5. This embodiment of the leak detecting gasket 500 is initially discussed with reference to FIGS. 5 and 5A collectively.

As with other embodiments of a leak detecting gasket in accordance with the disclosed principles, this embodiment of the gasket 500 comprises a circular shape; however, other shapes are also possible. As before, this version of the gasket 500 is also used to seal the ends of first and second conduits, such as piping or other conduits used to transport a fluid. Thus, this embodiment of the gasket 500 may again be used to seal tubing or piping used to transport hydrogen gas, but other uses are also encompassed within the principles disclosed herein.

The illustrated gasket 500 is again constructed with a core 505, which may be constructed from a rigid material such as metal, or may be constructed from a semi-rigid or non-rigid material, such as a plastic material, or even a cardboard or a paper-based material Of course, as with all embodiments disclosed herein, the core 505 of the leak detecting gasket 500 may be made from any advantageous material. Also as before, the core 505 provides the primary structure of the gasket 500 and surrounds a central opening 520 through the gasket for the passage of a fluid. Also included in this embodiment is a first non-sealing portion 510A having opposing non-sealing surfaces formed integrally with the core 505, and extending outwardly and defining a perimeter of the gasket 500. Alternatively, the first non-sealing portion 510A may be coupled to the outer perimeter of the core 505 using any advantageous material bonding techniques. Additionally, in other embodiments, the opposing surfaces of the first non-sealing portion 510A may include seals, such as o-rings (not illustrated), positioned proximate the outer edge of the non-sealing portion 510A on both opposing surfaces.

This embodiment of the gasket 500 is similar to the embodiment illustrated in FIG. 4 in that it includes a second non-sealing portion 510B also having opposing surfaces, as seen in FIG. 5A. The thickness of the core 505 at the second non-sealing portion 510B may be the same or different than the thickness of the first non-sealing portion 510A, as desired. In the illustrated embodiment, the thickness of the second non-sealing portion 510B is greater than the thickness of the first non-sealing portion 510A.

This embodiment of a leak detecting gasket 500 also includes first and second sealing portions 530A, 530B formed on opposing surfaces of the gasket core 505 facing the sealing surfaces of conduits flanges sealed together by the gasket 500. These sealing portions 530A, 530B include sealing surfaces comprised of advantageous sealing materials. Such materials may be compressible materials, and again may include a graphite facing or other advantageous material as described previously. Additionally, in this particular embodiment, each sealing surface of the sealing portions 530A, 530B is carried on a plurality of outwardly extending features 535. As before, these features 535 may again comprise various geometries (such as a sinusoidal or trapezoidal geometry, serrations, other smooth, peaked, or otherwise protruding features, or some combination thereof) to assist in sealing between the sealing portions 530A, 530B and the contact portions of the flanges of the adjoining conduits.

As can be seen in FIG. 5A, providing the second non-sealing portions 510B between the first and second sealing portions 530A, 530B creates a cavity on each opposing side of the gasket 500 when the gasket 500 is placed between the flanges of the adjoining conduits. As with the embodiment in FIG. 4, these cavities will funnel fluid leaking from the central opening 520 and across the second sealing portions 530B. A leak detection system 540 is again provided extending from the first non-sealing portion 510A, which may again be provided as a carrier structure 540 comprising a rigid or semi-rigid substrate. The carrier structure 540 is coupled to the gasket 500, in this embodiment on an area of the first non-sealing portion 510A. Additionally, a passageway 550 may be provided on each of the opposing sides of the carrier structure 540, and these passageways 550 can be connected to the cavities formed by the second non-sealing portions 510B via a first fluid junction 560 on both sides of the gasket 500. As such, if leaking fluid is present in the cavity on either side of the gasket 500 at the seal formed by second non-sealing portions 510B, that leaking fluid will pass from the cavity(ies), through the first fluid junction 560, and into one of the passageways 550 on either side of the carrier structure 540.

The carrier structure 540 may again be formed with detection pockets 570 on each of the opposing sides of the carrier structure 540 and each in fluid connection with a corresponding passageway 550. FIG. 5B illustrates a cross-sectional view of a portion of the carrier structure 540 taken along line G-G. This cross-sectional view illustrates the detection pockets 570 on opposing sides of the carrier structure 540. However, the carrier structure 540 in this embodiment of a leak detecting gasket 500 includes a detection component 580 disposed within the interior of the detection pockets 570. Additionally, the detection pockets 570 are enclosed by translucent surfaces 540A disposed along both sides of the carrier structure 540. These translucent surfaces 540A may be flexible, such a thin film, or may be rigid, such as transparent or semi-transparent plastic or similar material. The detection component 580 is selected such that as fluid leaking from the second sealing portion 530B of the gasket 500 fills the detection pockets 570, the detection component 580 provides an indicator that leaking fluid has been detected. For example, the detection component 580 may be a hydrogen detecting paint when the fluid passing through the gasket 500 and conduits is hydrogen.

In such embodiments, the carrier structure 540 may be positioned at the top of the gasket 500 when sealed between two adjoining conduits, and thus any leaking hydrogen would float upwards into one or both of the passageways 550 and then into one or both of the detection pockets 570 to contact the hydrogen detecting paint 580. The hydrogen detecting paint 580 would then provide a visual indication of the leaking hydrogen gas, such as by turning a different color, etc., while the translucent surfaces 540A of the carrier structure 540 allows this visual indication to be seen externally. The carrier structure 540 may again be sized to extend away from the gasket 500 sufficiently to provide such an indicator (visual or otherwise) of a leak at the gasket 500 to someone inspecting the conduit connection.

In addition to the first fluid junction 560, the leak detection system in this embodiment of a gasket 500 may again include a second fluid junction disposed on the opposite face of the gasket to facilitate communication of fluid to both detection pockets 570 in carrier structure 540. Specifically, as discussed above, the carrier structure 540 is connected to a point along the perimeter of the first non-sealing portion 510A and in contact with a side of the first sealing portion 530A. Therefore, if a leak occurs between one of the sealing surfaces of the first sealing portion 530A and a contact surface of one of the adjoining fluid conduits, the leaking fluid can contact the exterior of the carrier structure 540 proximate to the first sealing portion 530A. The exterior of the carrier structure at this location may thus include a further fluid detecting paint, other substance, or structure that can also provide an indication (visual or otherwise) of a leak at the second fluid junction. Notably, first sealing portion 530A may be machined, or otherwise modified, to accommodate the communication of leaked fluid through passageways 550. For example, first sealing portion 530A may be machined such that an opening is formed in the core which corresponds to the passageways. This opening may be partially defined by the modified core as well as the compressible material disposed on top of first sealing portion 530A wherein the compressible material effectively covers the opening or space formed into first sealing portion 530A.

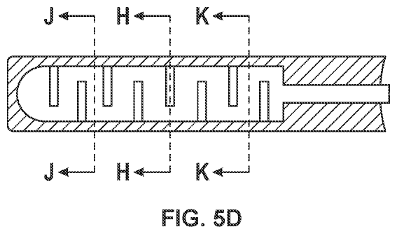

Turning now at FIG. 6, illustrated is a plan view of a sixth embodiment of a leak detecting gasket 600, in accordance with the disclosed principles. FIG. 6A illustrates a cross sectional view taken along line H-H of the embodiment of a leak detecting gasket 600 illustrated in FIG. 6. This embodiment of the leak detecting gasket 600 is initially discussed with reference to FIGS. 6 and 6A collectively.

As with other embodiments of a leak detecting gasket disclosed herein, this embodiment of the gasket 600 comprises a circular shape; however, other shapes are also possible. As before, this version of the gasket 600 is also used to seal the ends of first and second conduits, such as piping or other conduits used to transport a fluid. Thus, this embodiment of the gasket 600 may again be used to seal tubing or piping used to transport hydrogen gas, but other uses are also encompassed within the principles disclosed herein.

The illustrated gasket 600 is again constructed with a core 605, which may be constructed from a rigid material such as metal, or may be constructed from a semi-rigid or non-rigid material, such as a plastic material, or even a cardboard or a paper-based material As mentioned above, with all embodiments disclosed herein, the core 605 of the leak detecting gasket 600 may be made from any advantageous material. Also as before, the core 605 provides the primary structure of the gasket 600 and surrounds a central opening 620 through the gasket for the passage of a fluid. Also included in this embodiment is a first non-sealing portion 610A having opposing non-sealing surfaces formed integrally with the core 605, and extending outwardly and defining a perimeter of the gasket 600. Alternatively, the first non-sealing portion 610A may be coupled to the outer perimeter of the core 605 using any advantageous material bonding techniques. Additionally, in other embodiments, the opposing surfaces of the first non-sealing portion 610A may include seals, such as o-rings (not illustrated), positioned proximate the outer edge of the non-sealing portion 610A on both opposing surfaces.

This embodiment of the gasket 600 is similar to the embodiment illustrated in FIGS. 4 and 5 in that it includes a second non-sealing portion 610B also having opposing surfaces, as seen in FIG. 6A. The thickness of the core 605 at the second non-sealing portion 610B again may be the same or different than the thickness of the first non-sealing portion 610A, as desired. In the illustrated embodiment, the thickness of the second non-sealing portion 610B is greater than the thickness of the first non-sealing portion 610A, but this is not required.

This embodiment of a leak detecting gasket 600 also includes first and second sealing portions 630A, 630B formed on opposing surfaces of the gasket core 605 facing the sealing surfaces of conduits flanges sealed together by the gasket 600. These sealing portions 630A, 630B include sealing surfaces comprised of advantageous sealing materials. Such materials may be compressible materials, and again may include a graphite facing or other advantageous material as described previously. Additionally, as seen in other embodiments herein, each sealing surface of the sealing portions 630A, 630B is carried on a plurality of outwardly extending features 635. As before, these features 635 may again comprise ridges, serrations, or other peaked features 635 to assist in sealing between the sealing portions 630A, 630B and the contact portions of the flanges of the adjoining conduits.

As shown in FIG. 6A, providing the second non-sealing portions 610B between the first and second sealing portions 630A, 630B creates a cavity on each opposing side of the gasket 600 when the gasket 600 is sealed between the flanges of the adjoining conduits. As with the embodiment in FIG. 5, these cavities will funnel fluid leaking from the central opening 620 and across the second sealing portions 630B. A leak detection system 640 is again provided extending from the first non-sealing portion 610A, which may again be provided as a carrier structure 640 comprising a rigid or semi-rigid substrate. The carrier structure 640 is coupled to the gasket 600, in this embodiment on an area of the first non-sealing portion 610A.

In this embodiment of a leak detection system, instead of a passageway provided on each side of the carrier structure 640, a detection component reservoir 650 is connected to the cavities formed by the second non-sealing portions 610B via a pressure sensitive diaphragm 670 at a first fluid junction 660. Moreover, the reservoir 650 may be sized such that it connects to both cavities formed by the second non-sealing portions 610B on both sides of the gasket 600. Therefore, if leaking fluid is present in the cavity on either side of the gasket 600 at the seal formed by second non-sealing portions 610B, that leaking fluid will pass from the cavity(ies), and apply pressure to the diaphragm 670 in the first fluid junction 660. The pressure applied by the leaking fluid onto the pressure sensitive diaphragm 670 will cause the diaphragm 670 to rupture. In alternative embodiments, two diaphragms positioned at the openings of two reservoirs, one on each side of the gasket 600, may also be provided.

FIG. 6B illustrates a cross-sectional view of a portion of the carrier structure 640 taken along line I-I. This cross-sectional view illustrates the display faces 640A on opposing sides of the carrier structure 640. Additionally, a portion of the reservoir 650 and the detection liquid 680 held therein can also be seen, as can the passages 690 located between the reservoir 650 and the display faces 640A. As with other embodiments, the carrier structure 640 may be positioned at the top of the gasket 600 when sealed between two adjoining conduits, and thus any leaking hydrogen would float upwards and against the diaphragm(s) 670. The leaking hydrogen ruptures the diaphragm(s) 670 and passes into the reservoir 650, which in turn forces the detection liquid 680 through the passages 690 and onto the display faces 640A. The detection liquid flowing onto the display faces 640A would then provide a visual indication of the leaking hydrogen gas which can be seen externally. The carrier structure 640 may again be sized to extend away from the gasket 600 sufficiently to provide such a visible indicator of a leak at the gasket 600 to someone visually inspecting the conduit connection.

The carrier structure 640 in this embodiment is formed with a display face 640A on one or both sides of the structure 640, and these faces 640A provide surfaces onto which a detection component 680, such as a paint or similarly colored liquid, may flow. For example, the detection component 680 may be a hydrogen detecting paint when the fluid passing through the gasket 600 and conduits is hydrogen. The detection component may alternatively comprise a different detection mechanism such as an electrical sensor configured to detect changes in pressure. Operationally, as the leaking fluid ruptures the diaphragm(s) 670, the detection liquid 680 is pushed from the reservoir 650, through passages 690 positioned at the junction between the reservoir 650 and the display faces 640A. In exemplary embodiments, the passages 690 are comprised of plugs or similarly functioning devices that give way and permit the liquid 680 to be forced from the reservoir onto the display faces 640A. The display faces 640A may include a knurling or other texturing to assist in hold the detection liquid 680 on the faces 640A, as opposed to the liquid simply running off of them. Alternatively, an absorbent material or paint may be placed on the display faces 640A to assist in maintaining the detection liquid being dispersed on the faces 640A during a leak in the gasket 600.

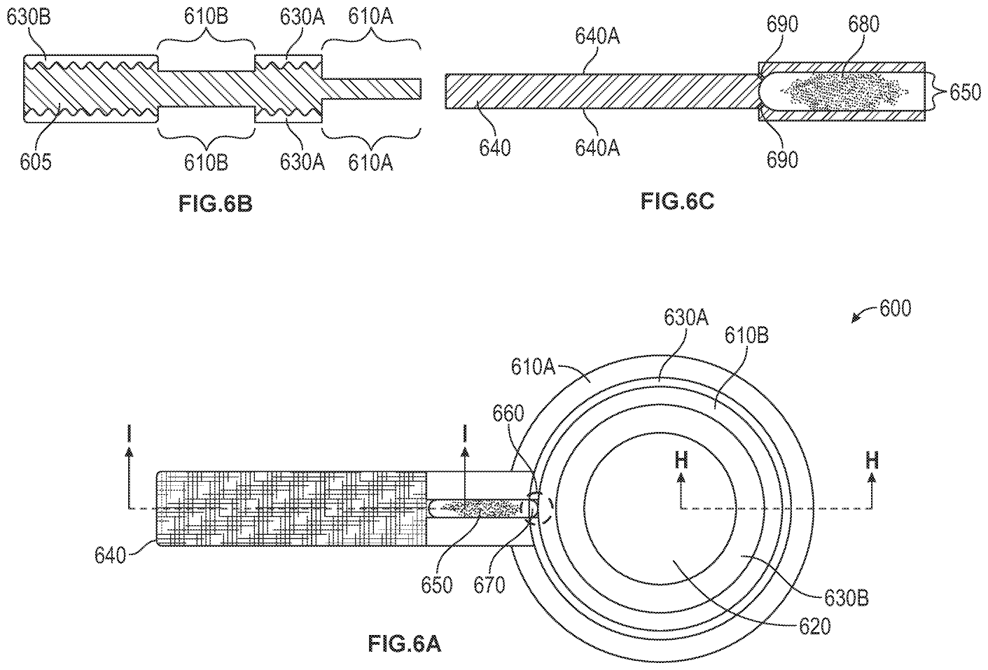

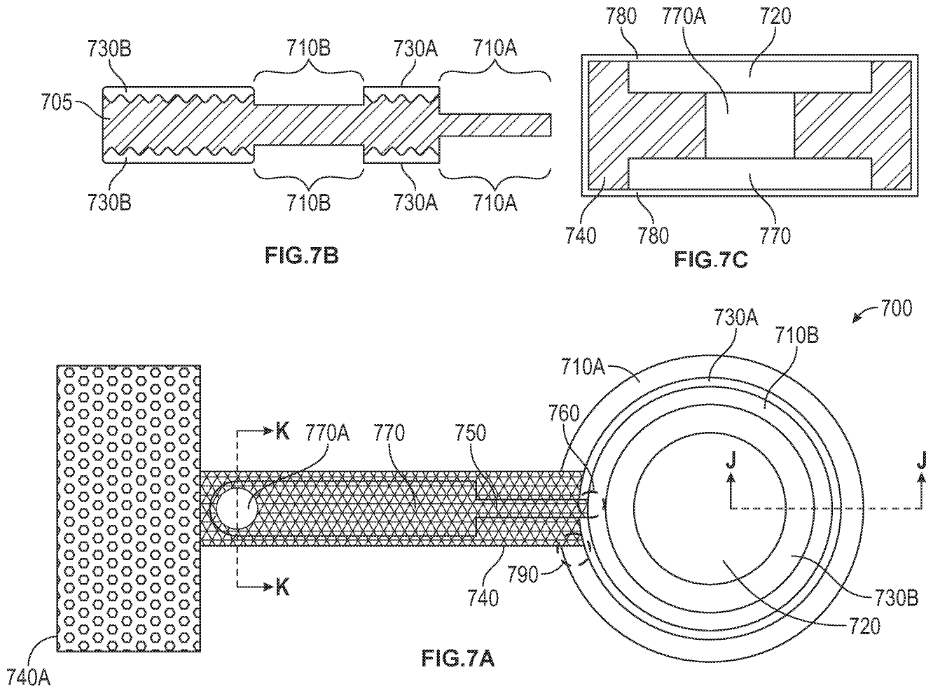

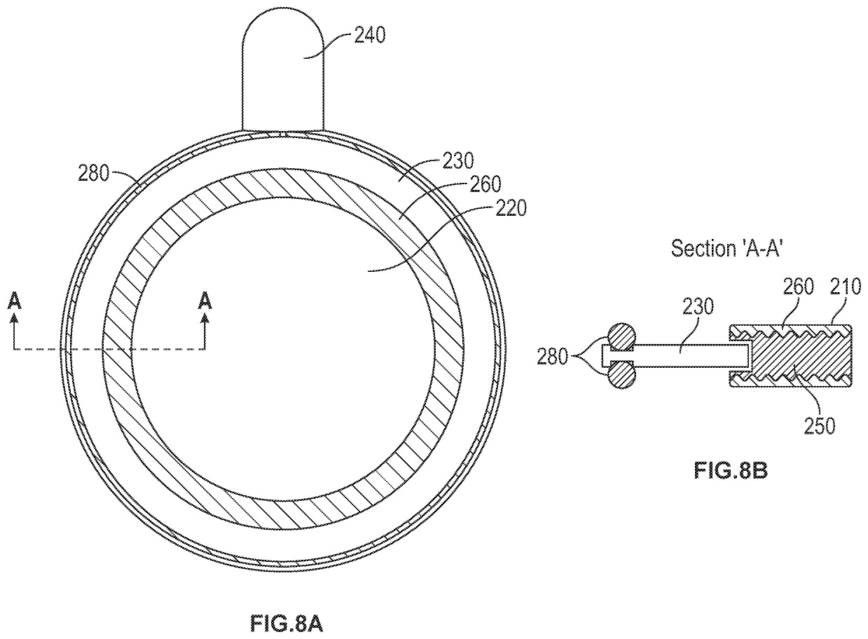

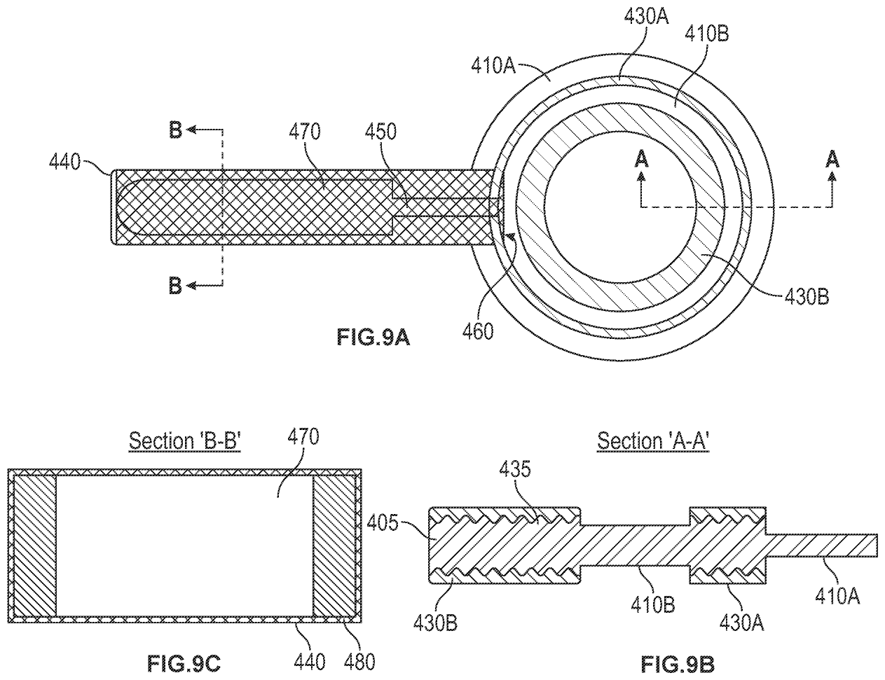

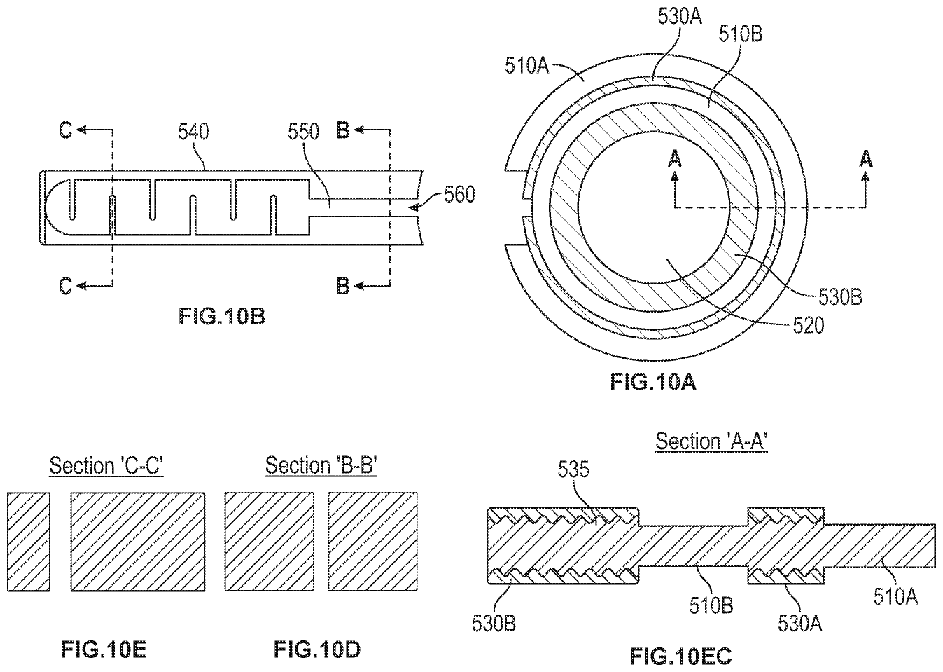

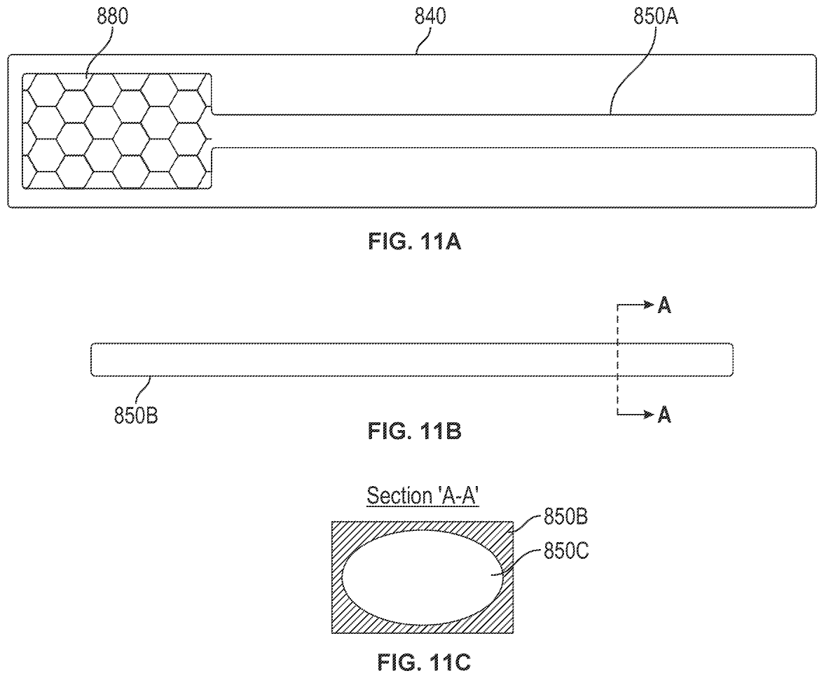

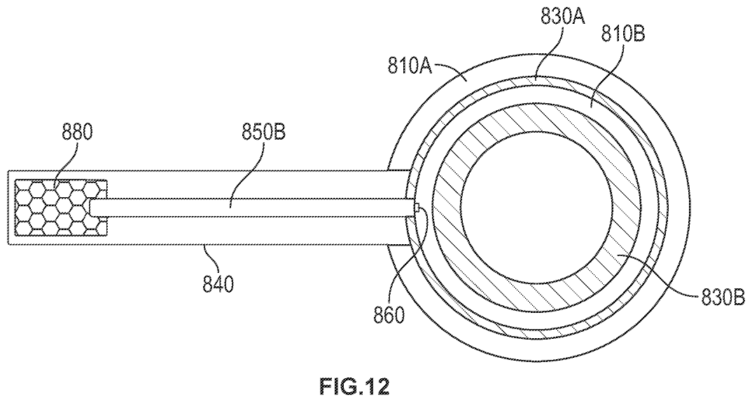

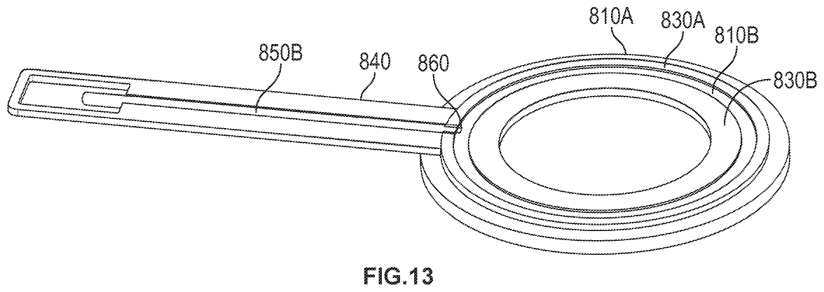

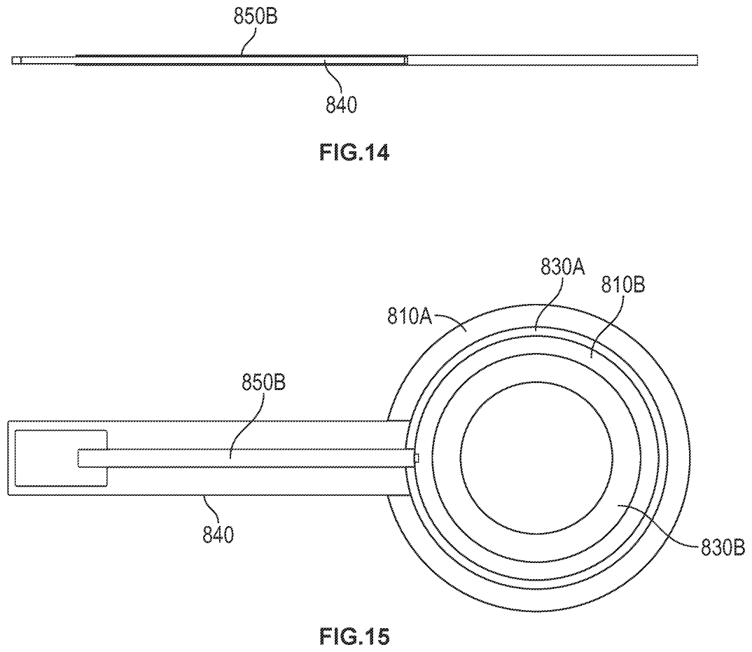

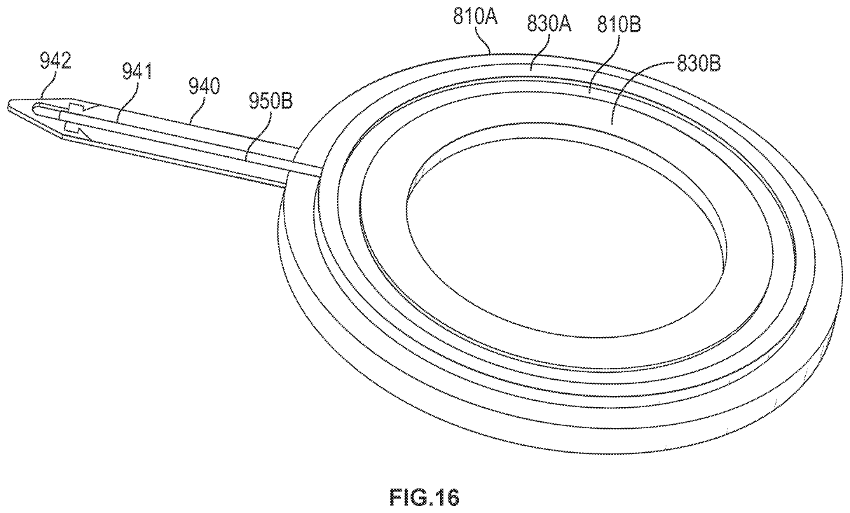

Turning finally to FIG. 7, illustrated is a plan view of a seventh embodiment of a leak detecting gasket 600, in accordance with the disclosed principles. FIG. 7A illustrates a cross sectional view taken along line J-J of the embodiment of a leak detecting gasket 700 illustrated in FIG. 7. This embodiment of the leak detecting gasket 700 is initially discussed with reference to FIGS. 7 and 7A collectively.

As with other embodiments of a leak detecting gasket in accordance with the disclosed principles, this embodiment of the gasket 700 comprises a circular shape; however, as with all embodiments of the gaskets disclosed herein, other shapes are also possible. As before, this version of the gasket 700 is also used to seal the ends of first and second conduits, such as piping or other conduits used to transport a fluid. Thus, this embodiment of the gasket 700 may again be used to seal tubing or piping used to transport hydrogen gas, but other uses are also encompassed within the principles disclosed herein.

The illustrated gasket 700 is again constructed with a core 705, which may be constructed from a rigid material such as metal, or may be constructed from a semi-rigid or non-rigid material, such as a plastic material, or even a cardboard or a paper-based material Of course, as with all embodiments disclosed herein, the core 705 of the leak detecting gasket 700 may be made from any advantageous material. Also as before, the core 705 provides the primary structure of the gasket 700 and surrounds a central opening 720 through the gasket for the passage of a fluid. Also again included in this embodiment is a first non-sealing portion 710A having opposing non-sealing surfaces formed integrally with the core 705, and extending outwardly and defining a perimeter of the gasket 700. Alternatively, the first non-sealing portion 710A may be coupled to the outer perimeter of the core 705 using any advantageous material bonding techniques. Additionally, in other embodiments, the opposing surfaces of the first non-sealing portion 710A may include seals, such as o-rings (not illustrated), positioned proximate the outer edge of the non-sealing portion 710A on both opposing surfaces.

This embodiment of the gasket 700 is similar to the embodiment illustrated in FIGS. 4, 5 and 6 in that it includes a second non-sealing portion 710B also having opposing surfaces, as seen in FIG. 7A. The thickness of the core 705 at the second non-sealing portion 710B may be the same or different than the thickness of the first non-sealing portion 710A, as desired. In the illustrated embodiment, the thickness of the second non-sealing portion 710B is again greater than the thickness of the first non-sealing portion 710A.

This embodiment of a leak detecting gasket 700 also includes first and second sealing portions 730A, 730B formed on opposing surfaces of the gasket core 705 facing the sealing surfaces of conduits flanges sealed together by the gasket 700. These sealing portions 730A, 730B include sealing surfaces comprised of advantageous sealing materials. Such materials may be compressible materials, and again may include a graphite facing or other advantageous material as described previously. Additionally, in this particular embodiment, each sealing surface of the sealing portions 730A, 730B is carried on a plurality of outwardly extending features 735. As before, these features 735 may again comprise ridges, serrations, or other peaked features 735 to assist in sealing between the sealing portions 730A, 730B and the contact portions of the flanges of the adjoining conduits.

As can be seen in FIG. 7A, providing the second non-sealing portions 710B between the first and second sealing portions 730A, 730B creates a cavity on each opposing side of the gasket 700 when the gasket 700 is placed between the flanges of the adjoining conduits. As with the embodiments in FIGS. 4, 5 and 6, these cavities will funnel fluid leaking from the central opening 720 and across the second sealing portions 730B. A leak detection system 740 is again provided extending from the first non-sealing portion 710A, which may again be provided as a carrier structure 740 comprising a rigid or semi-rigid substrate. The carrier structure 740 is coupled to the gasket 700, in this embodiment on an area of the first non-sealing portion 710A. Additionally, a passageway 750 may be provided on each of the opposing sides of the carrier structure 740, and these passageways 750 can be connected to the cavities formed by the second non-sealing portions 710B via a first fluid junction 760 on both sides of the gasket 700. As such, if leaking fluid is present in the cavity on either side of the gasket 700 at the seal formed by second non-sealing portions 710B, that leaking fluid will pass from the cavity(ies), through the first fluid junction 760, and into one of the passageways 750 on either side of the carrier structure 740. Alternatively, a single, larger passageway 750 that connects to both of the cavities on either side of the gasket 700 may also be employed.

The carrier structure 740 may again be formed with detection pockets 770 on each of the opposing sides of the carrier structure 740 and each in fluid connection with a corresponding passageway(s) 750. FIG. 7B illustrates a cross-sectional view of a portion of the carrier structure 740 taken along line K-K. This cross-sectional view illustrates the detection pockets 770 on opposing sides of the carrier structure 740. A through-hole 770A joining the pockets 770 may also be provided, as shown. Also, the carrier structure 740 in this embodiment of a leak detecting gasket 700 again includes a detection component 780 placed on the exterior surfaces of the carrier structure 740, and providing one of the enclosing surfaces of each of the detection pockets 770.

The detection component 780 is selected such that as fluid leaking from the second sealing portion 730B of the gasket 700 fills the detection pockets 770, the detection component 780 provides a visual indicator that leaking fluid has been detected. Again, in exemplary embodiments, the detection component 780 may be a hydrogen detecting thin film when the fluid passing through the gasket 700 is hydrogen. In such embodiments, the carrier structure 740 may be positioned at the top of the gasket 700 when sealed between two adjoining conduits, and thus any leaking hydrogen would float upwards into one or both of the passageways 750 and then into one or both of the detection pockets 770. The hydrogen detecting film 780 would then provide a visual indication of the leaking hydrogen gas, such as by turning a different color, etc. The carrier structure 740 may again be sized to extend away from the gasket 700 sufficiently to provide such a visible indicator of a leak at the gasket 700 to someone visually inspecting the conduit connection.

In addition to the first fluid junction 760, the leak detection system in this embodiment of a gasket 700 may further include a second fluid junction disposed on the opposite face of the gasket to facilitate communication of fluid to both detection pockets 770 in carrier structure 740. Specifically, as discussed above, the carrier structure 740 is connected to a point along the perimeter of the first non-sealing portion 710A and in contact with a side of the first sealing portion 730A. As such, if a leak occurs between one of the sealing surfaces of the first sealing portion 730A and a contact surface of one of the adjoining fluid conduits, the leaking fluid can contact the detecting film 780 on the outer portion of the carrier structure 740 proximate the first sealing portion 730A at the second fluid junction. Once contacted, the detecting film 780 can then provide a visual indication of the leak in the manner discussed above.

Additionally included in this embodiment of a leak detecting gasket 700 according to the disclosed principles is a secondary leak detection component 740A positioned at the distal end of the carrier structure and which may provide an additional or an alternative indication of a detected leak in the seal of the gasket 700. In the illustrated embodiment, the secondary detection component 740A comprises a sensor, and more specifically, a hydrogen sensor when the fluid passing through the gasket 700 is hydrogen. In some embodiments, the hydrogen sensor 740A is configured to trigger when leaking hydrogen is detected via the hydrogen detecting thin film disposed on the exterior of the carrier structure 740. In other embodiments, the hydrogen sensor 740A is configured to trigger when leaking hydrogen is detecting within one of the pockets 770 within the carrier structure 740. For example, the distal ends of the pockets 770 may include an opening so that hydrogen gas within the pockets 770 passed into the hydrogen sensor 740A to trigger it. Of course, in embodiments where the leaking fluid is a different element or composition, then the secondary detection component 740A can be selected to detect that different element or composition.

Once triggered, the sensor 740A can provide any of a number of indications of a detected fluid leak at the gasket 700. For example, the sensor 740A may provide a visual indication, similar to that provided by the first detection component 780. Alternatively, the sensor 740A may be comprised of a transmitter configured to transmit a signal to a receiving device associated with a detection system when a leak is detected. As before, a plurality of electronic detection systems may be used in corresponding leak detecting gaskets so that all conduit junctions employing these gaskets may be monitored by a single system. Furthermore, such electronic detection system(s) may instead, or additionally, include visual and audible notifications when leaking fluid is detected. For example, one or more lights may be illuminated when a leak is detected, or a sound played, either on the electronic detection system itself or a device to which the electronic detection system is connected when a leaking fluid is detected.

In some embodiments, when the sealing and non-sealing features of the gasket are formed (for example, through welding of two compatible metals), the resulting substantially annular structure may be machined, or otherwise modified, to accommodate a corresponding carrier structure. This is shown in FIG. [x] which depicts a modified gasket structure and a corresponding carrier structure.

Looking to FIG. [y], a further embodiment of the present disclosure may utilize a multi-piece carrier structure comprising a primary carrier structure body 840 having a passageway, a fluid transfer vessel 850b, and a detection element 880. In such an embodiment, the fluid transfer vessel 850b may be disposed in the passageway way of the primary carrier structure body 840 thereby enabling fluid communication through fluid transfer vessel 850b between the detection element 880 and the fluid junction point 860. Fluid transfer vessel 850b serves to guide any leaked fluid to the detection element 880. Fluid transfer vessel 850b may be a conduit, pipe, tube, or other similar structure capable of communicating fluid from one point to another. An exemplary fluid transfer vessel is shown in FIG. [y]. Fluid transfer vessel 850b may be fabricated separately from primary carrier structure body 840 and later become secured together via conventional means (such as welding). Alternatively, a carrier structure in accordance with such an embodiment may be fabricated as a single piece.

A further embodiment of a carrier structure is shown in FIG. [z]. In such an embodiment, the carrier structure features a primary carrier structure body 941 and removable detection cap 942. Removable detection cap 942 may be configured for reversible engagement with primary carrier structure body 941 and allows for replacement of a detection element. Removable detection cap 942 may be configured to accommodate reversible engagement to primary carrier structure body 941 via any conventional means (for example, a frictional fit, use of interlocking features (not depicted), or a threaded engagement (not depicted)). The remainder of the carrier structure may be configured in accordance with other embodiments of the present disclosure.

While this disclosure has been particularly shown and described with reference to preferred embodiments, it will be understood by those skilled in the pertinent field art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto, as permitted by applicable law. Moreover, any combination of the above-described elements in all possible variations thereof is encompassed by the disclosure unless otherwise indicated herein or otherwise clearly contradicted by context.

Also, while various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

The uses of the terms “a” and “an” and “the” and similar references in the context of describing the invention(s) (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Also, although the open-ended term “comprises” is generally used herein, additional embodiments can be formed by substituting the terms “consisting essentially of” or “consisting of.” Moreover, any combination of the above-described features or elements in all possible variations thereof is encompassed by the disclosed principles unless otherwise indicated herein or otherwise clearly contradicted by context.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

Moreover, the Abstract is provided to comply with 37 C.F.R. § 1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the following claims are hereby incorporated into the Detailed Description, with each claim standing on its own as a separate embodiment.

Any and all publications, patents, and patent applications cited in this specification are herein incorporated by reference as if each individual publication, patent, or patent application were specifically and individually indicated to be incorporated by reference and set forth in its entirety herein.

What is claimed is:

1. A leak detecting gasket configured to seal sealing ends of first and second components having a fluid passing therethrough, the gasket comprising:
a gasket core surrounding a central opening configured to receive the fluid therethrough;
at least one sealing portion of the gasket core having a first thickness, and having first and second opposing sealing surfaces configured to contact corresponding first and second sealing ends of the first and second components;
at least one non-sealing portion disposed along all of an outer perimeter of the gasket core, the at least one non-sealing portion having a second thickness less than the first thickness, and having first and second opposing surfaces configured not to contact the first and second sealing ends of the first and second components; and
a leak detection system comprising:
a carrier structure outwardly extending from the at least one non-sealing portion, and
at least one detection component disposed on the carrier structure, wherein the at least one detection component provides an indication in response to contact from fluid passing from the central opening and across at least one of the first or second sealing surfaces.

2. A leak detecting gasket according to claim 1, wherein the carrier structure comprises at least one rigid substrate extending from a portion of the at least one non-sealing portion, wherein the at least one detection component is disposed on at least one outer surface of the at least one rigid substrate and configured to provide an indication when contact by a fluid.

3. A leak detecting gasket according to claim 2, wherein the at least one detection component comprises a hydrogen sensing substance.

4. A leak detecting gasket according to claim 2, further comprising a seal disposed on each of the first and second opposing surfaces of the at least one non-sealing portion proximate to and along all of an outer edge of the at least one non-sealing portion, the outer perimeter of the gasket core and the seals defining corresponding first and second cavities therebetween and between each of the first and second opposing surfaces and the corresponding first and second sealing ends of the first and second components.

5. A leak detecting gasket according to claim 4, wherein each seal comprises an o-ring, each of the first and second opposing surfaces of the at least one non-sealing portion comprising a groove sized to receive a portion of each corresponding o-ring.

6. A leak detecting gasket according to claim 4, further comprising a check valve disposed between the at least one rigid substrate and a portion of each seal.

7. A leak detecting gasket according to claim 2, wherein the carrier structure comprises a plurality of rigid substrates extending from corresponding portions of the outer perimeter of the at least one non-sealing portion, each of the plurality of rigid substrates comprising a detection component.

8. A leak detecting gasket according to claim 1, wherein the at least one detection component is an electronic system providing an electronic signal in response to detecting a leaking fluid.

9. A leak detecting gasket according to claim 1, wherein the at least one non-sealing portion and the gasket core are integrally formed.

10. A leak detecting gasket according to claim 1, wherein the first and second opposing sealing surfaces of the at least one sealing portion comprise a compressible material disposed on a rigid gasket core.

11. A leak detecting gasket according to claim 10, wherein the compressible material comprises graphite facing providing the first and second opposing sealing surfaces.

12. A leak detecting gasket according to claim 10, wherein the gasket core comprises first and second pluralities of ridges extending towards each of the corresponding first and second sealing ends of the first and second components, the first and second pluralities of ridges comprising the at least one sealing portion and carrying the first and second opposing sealing surfaces.

13. A leak detecting gasket configured to seal sealing ends of first and second components having a fluid passing therethrough, the gasket comprising:
a gasket core surrounding a central opening configured to receive the fluid therethrough;
at least two sealing portions of the gasket core having a first thickness, and each having first and second opposing sealing surfaces configured to contact corresponding first and second sealing ends of the first and second components;
a first non-sealing portion disposed along all of an outer perimeter of the gasket core, the first non-sealing portion having a second thickness less than the first thickness, and having first and second opposing surfaces configured not to contact the first and second sealing ends of the first and second components;
a second non-sealing portion disposed between two of the at least two sealing portions, the second non-sealing portion having a third thickness less than the first thickness and having first and second opposing surfaces configured not to contact the first and second sealing ends of the first and second components to create cavities on opposing sides of the gasket, said cavities configured to funnel fluid leaking from the central opening and across one of the sealing portions; and
a leak detection system comprising:
a carrier structure outwardly extending from the at least one non-sealing portion and comprising at least one passageway in contact with one or more of the cavities and configured to receive the funneled leaking fluid therefrom; and
at least one detection component disposed on the carrier structure, wherein the at least one detection component provides an indication in response to contact from fluid received from the at least one passageway.

14. A leak detecting gasket according to claim 13, wherein the carrier structure comprises at least one rigid substrate extending from a portion of the at least one non-sealing portion, wherein the rigid substrate comprises at least one detection pocket in fluid connection with the at least one passageway, the at least one detection proximate the at least one detection pocket.

15. A leak detecting gasket according to claim 14, wherein the at least one detection component is disposed on at least one outer surface of the at least one rigid substrate and configured to provide an enclosing surface of the at least one detection pocket.

16. A leak detecting gasket according to claim 14, wherein the at least one detection component is disposed within the at least one detection pocket, further comprising an at least partially translucent component on an exterior surface of the carrier structure over the at least one detection component and configured to provide visual inspection of the at least one detection component.

17. A leak detecting gasket according to claim 14, further comprising a sensor positioned at a distal end of the carrier structure and in fluid communication with the at least one detection pocket, the sensor configured to detect presence of the leaking fluid within the at least one detection pocket and provide a notification in response thereto.

18. A leak detecting gasket according to claim 14, wherein the detection component is a liquid, wherein the at least one passageway comprises a reservoir holding the liquid and having a diaphragm at a fluid junction with at least one of the cavities, and wherein the diaphragm is configured to rupture from pressure applied by the leaking fluid thereby causing the liquid detection component to be disbursed to at least one display face on the carrier structure.

19. A leak detecting gasket according to claim 13, wherein the first and second opposing sealing surfaces of the first and second sealing portions each comprise a compressible material disposed on a rigid gasket core.

20. A leak detecting gasket according to claim 19, wherein the gasket core comprises first and second pluralities of ridges extending towards each of the corresponding first and second sealing ends of the first and second components, the first and second pluralities of ridges comprising the first and second sealing portions and carrying the corresponding first and second opposing sealing surfaces.
